(19) United States
(12) Patent Application Publication
(10) Pub. No.: US 2026/0314670 A1
(43) Pub. Date: Oct. 15, 2026

(54) ELECTRONIC CIGARETTE VAPORIZING CORE

(71) Applicant: SHENZHEN HAPPY VAPING TECHNOLOGY LIMITED, Shenzhen, Guangdong (CN)

(72) Inventors: Guangrong Lin, Huizhou, Guangdong (CN); Xianbin Zheng, Huizhou, Guangdong (CN)

(21) Appl. No.: 18/860,015

(22) PCT Filed: Mar. 15, 2024
(86) PCT No.: PCT/CN2024/081927

§ 371 Date: Oct. 25, 2024

(30) Foreign Application Priority Data
Jul. 14, 2023 (CN) 202321851854.1

(51) Int. Cl. A24F 40/46; A24F 40/10; H05B 3/03

(52) U.S. Cl. CPC A24F 40/46; A24F 40/10; H05B 3/03

(57) ABSTRACT

The disclosure discloses an electrical cigarette vaporizing core, comprising a buffer layer, a porous ceramic layer, and a heating resistor layer, which are overlapped and tightly connected in sequence, both the buffer layer and the porous ceramic layer are provided with tiny interstices or pores for adsorbing, permeating and conducting vaporizing liquid, a porosity of the buffer layer is greater than that of the porous ceramic layer, the heating resistor layer is provided with through holes or interstices, both ends of one side of the heating resistor layer are connected with electrode terminals for electrically connecting with positive and negative electrodes of a power supply, respectively. The disclosure has advantages that the buffer layer of the electrical cigarette vaporizing core has a certain separation and buffering effects. It can ensure sufficient liquid supply, but would not lead to excessive permeation to cause excessive liquid supply and leakage.

### TECHNICAL FIELD

The disclosure relates to the field of the electronic cigarette vaporizing technology, and more particularly, the disclosure relates to an electronic cigarette vaporizing core.

### BACKGROUND

An electronic cigarette, as an electronic vaporizing device, generally includes a battery part and a vaporizer. The battery part may be mounted with a battery for supplying power to the vaporizer. The vaporizer comprises a vaporizing core disposed therein. The vaporizing core can heat and atomize the to-be-vaporized solution, i.e., the vaporizing liquid, into vapor or aerosol when powered on. The vaporizing liquid is namely the cigarette liquid stored in the liquid storage chamber of the vaporizer.

Most of the electronic cigarette vaporizing cores available on the market use porous ceramic body materials, and it is known in the art that the porous ceramic body materials may be used for permeation and conduction of the vaporizing liquid. Such porous ceramic bodies are usually provided inside with liquid guiding grooves, liquid guiding holes, or airflow through-holes. However, such grooves and holes may increase the difficulty of the manufacturing process of the porous ceramic heating elements and may lead to cracking during high-temperature operation, thereby making the vaporizer prone to malfunction and liquid leakage. In addition, as the upper surface of the porous ceramic body placed in the vaporizer is directly in contact with the vaporizing liquid in the liquid storage chamber, the amount of liquid supply will be large when the upper surface is saturated with the vaporizing liquid. In such a case, it may be prone to lead to excessive permeation during operation and thus may result in excessive liquid supply and leakage. Otherwise, when the vaporizer is shaken or has low amount of vaporizing liquid such that its upper surface is not saturated, it may be prone to insufficient liquid supply, low vaporization amount, and unstable vaporization.

Moreover, during the operation of the vaporizer, when a user vapes and inhales the vapor of the electronic cigarette, a certain negative pressure will be generated in the vaporizing chamber and the vaporizing channel to facilitate the suction of vapor or airflow. As the cigarette liquid in the liquid storage chamber is consumed, a certain negative pressure may be generated in the liquid storage chamber. Such negative pressure is difficult to eliminate due to the seal performance of the liquid storage chamber. Thus, after a certain period of accumulation, the negative pressure in the liquid storage chamber may gradually increase. When the negative pressure in the liquid storage chamber accumulates to a certain extent, the vaporizing liquid stored inside may be suctioned back due to the negative pressure and will be difficult to permeate through the porous ceramic body, thereby causing a lack of vaporizing liquid during the operation of the heating element, leading to a continuous reduction in the amount of vaporization, and even easily resulting in erosion and damage of the porous ceramic heating element caused by dry-heating, and burning taste.

### SUMMARY

Technical Problems

In order to overcome the abovementioned disadvantages, the disclosure provides an electronic cigarette vaporizing core which avoids leakage of the vaporizing liquid and eliminates negative pressure in the liquid storage chamber.

### Technical Solutions

The disclosure provides a technical solution as follows. An electrical cigarette vaporizing core comprises a buffer layer, a porous ceramic layer, and a heating resistor layer, which are overlapped and tightly connected in sequence, both the buffer layer and the porous ceramic layer are provided all over with numerous non-through tiny interstices or tiny pores for adsorbing, permeating and conducting vaporizing liquid, a porosity of the buffer layer is greater than a porosity of the porous ceramic layer, the heating resistor layer is provided with a plurality of through holes or interstices extending there-through to allow the vaporizing liquid that is vaporized by heating to escape in a vapor form, both ends of one side of the heating resistor layer are connected with electrode terminals for electrically connecting with positive and negative electrodes of a power supply, respectively.

Preferably, the electrode terminals may constitute an electrode layer which is arranged between the porous ceramic layer and the heating resistor layer.

Preferably, the buffer layer may entirely cover a surface of the porous ceramic layer, with at least an edge of a side of the buffer layer extending beyond an edge of a corresponding side of the porous ceramic layer.

Preferably, a distance that the edge of the side of the buffer layer extending beyond the edge of the corresponding side of the porous ceramic layer is set to 0.1 mm to 1.2 mm.

Preferably, a thickness of the buffer layer may be less than or equal to a thickness of the porous ceramic layer.

Preferably, a thickness of the buffer layer may be set to 0.5 mm to 2.0 mm, and a thickness of the porous ceramic layer may be set to 1.0 mm to 2.5 mm.

Preferably, the buffer layer may be centrally provided with at least one through hole extending there-through.

Preferably, the heating resistor layer may be composed of a porous metal heating film, a metal heating mesh, or a porous metal heating sheet.

Preferably, the electrode layer and the heating resistor layer may be formed on the surface of the porous ceramic layer by physical vapor deposition process by using different conductive metal materials, respectively, and a resistance of the electrode layer may be much smaller than that of the heating resistor layer.

Preferably, the buffer layer may be a soft body made of foam metal materials, polymeric porous materials, organic cotton materials, linen-cotton blend materials, non-woven fabrics, or plant fiber materials.

### Advantages

The porous ceramic layer of the e-cigarette vaporizing core is provided inside without any liquid guiding groove, liquid guiding hole, or airflow through-hole. Thus, the porous ceramic layer is easy to manufacture and produce and has improved yield. It reduces the risk of cracking during high-temperature operation, thereby making the vaporizing core not prone to malfunction. The disclosure is provided with the buffer layer, which tightly abuts on the porous ceramic layer, to prevent the upper surface of the porous ceramic layer from being directly in contact with the vaporizing liquid in the liquid storage chamber, and achieve a certain separation and buffering effects. It can ensure sufficient liquid supply, but would not lead to excessive permeation to cause excessive liquid supply and leakage. In addition, according to the vaporizing core of the disclosure, as one side edge of the buffer layer extends beyond the corresponding side edge of the porous ceramic layer by a distance, the gap can be formed. Thus, when a certain negative pressure is generated in the liquid storage chamber, the gas in the vaporizing chamber can flow upward through the gap and further pass through the interstices or pores inside the buffer layer and holes, flow upward slowly to arrive at the liquid storage chamber. Thus, the negative pressure in the liquid storage chamber can be eliminated. Consequently, during the operation of the vaporizing core, it can avoid the lack of liquid caused by the negative pressure in the liquid storage chamber, the erosion and damage of the porous ceramic layer caused by dry-heating, and the burning taste.

### BRIEF DESCRIPTION OF THE DRAWINGS

FIG. 1 is a perspective view of a vaporizing core according to an embodiment of the disclosure;

FIG. 2 is a front view 1 of a vaporizing core according to an embodiment of the disclosure;

FIG. 3 is an exploded perspective view of a vaporizing core according to an embodiment of the disclosure;

FIG. 4 is a front view 2 of a vaporizing core according to an embodiment of the disclosure;

FIG. 5 is a cross-sectional view illustrating a vaporizing core mounted in a cavity of a vaporizing base according to an embodiment of the disclosure;

FIG. 6 is a perspective view of a buffer layer of a vaporizing core according to a further embodiment of the disclosure.

### DETAILED DESCRIPTION OF ILLUSTRATED EMBODIMENTS

The electronic cigarette vaporizing core of the disclosure may be mounted in the electronic cigarette vaporizer, and the electronic cigarette vaporizer may be connected with a battery part to constitute an electronic cigarette. The vaporizing core of the disclosure can heat and atomize the to-be-vaporized solution, i.e., the vaporizing liquid, into vapor, aerosol, or e-cigarette vapor fog when powered on. The vaporizing liquid is namely the cigarette liquid stored in the liquid storage chamber of the vaporizer.

### Embodiments of the Disclosure

The disclosure will be further explained in detail with reference to particular embodiments.

### Embodiment

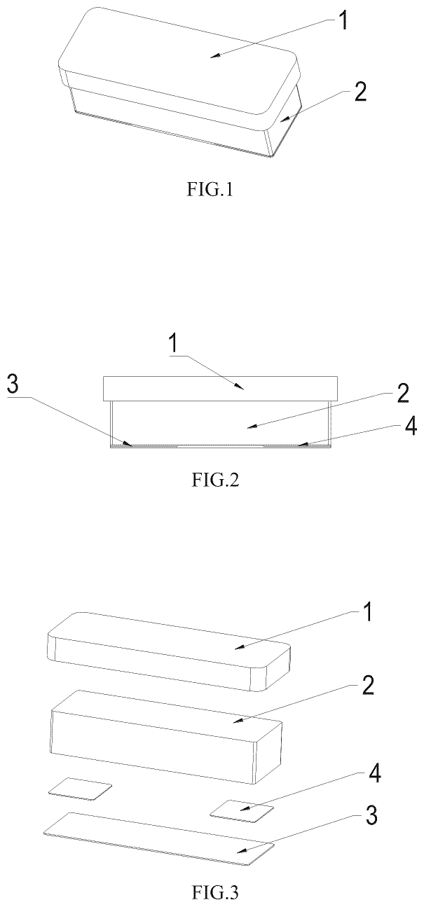

Referring to FIGS. 1-3, the e-cigarette vaporizing core in the embodiment mainly consists of a buffer layer 1, a porous ceramic layer 2, and a heating resistor layer 3, which are overlapped and tightly connected in sequence from top to bottom. Herein, both the buffer layer 1 and the porous ceramic layer 2 are provided with numerous non-through tiny interstices or tiny pores which are uniformly distributed all over, to facilitate the adsorption, permeation and conduction of the vaporizing liquid. The porosity of the buffer layer 1 is greater than that of the porous ceramic layer 2, which means that the buffer layer 1 has more or larger tiny interstices or tiny pores in comparison with the porous ceramic layer 2. It enables the buffer layer 1 to exhibit better liquid permeability performance and air permeability performance than the porous ceramic layer 2. The heating resistor layer 3 is provided with several through holes or interstices, to allow the vaporizing liquid vaporized by heating to escape in a vapor form. Additionally, electrode terminals 4 are arranged at both ends of one side of the heating resistor layer 3. The electrode terminals 4 are used for electrical connection with the positive and negative electrodes of the power supply, respectively. In the embodiment, the electrode terminals 4 make an electrode layer 4 which is positioned between the porous ceramic layer 2 and the heating resistor layer 3.

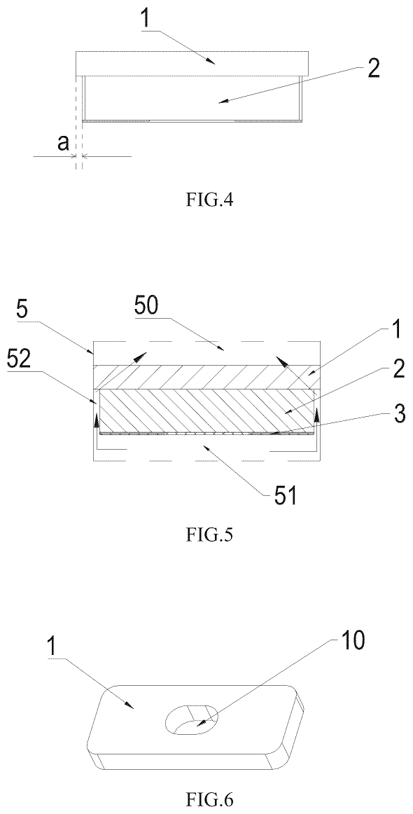

Referring to FIG. 4, in order to ensure that the buffer layer 1 has better liquid permeability performance and air permeability performance in comparison with the porous ceramic layer 2, the thickness of the buffer layer 1 may be less than or equal to that of the porous ceramic layer 2. Preferably, the thickness of the buffer layer 1 in the embodiment may be set to 0.5 mm to 2.0 mm, and the thickness of the porous ceramic layer 2 may be set to 1.0 mm to 2.5 mm.

Referring to FIG. 4, the buffer layer 1 may cover the entire surface of the porous ceramic layer 2, with at least one side edge of the buffer layer 1 extending beyond a corresponding side edge of the porous ceramic layer 2. Preferably, in the embodiment, the distance a that the edge of the one side of the buffer layer 1 extending beyond the edge of the corresponding side of the porous ceramic layer 2 may be set to 0.1 mm to 1.2 mm. Such distance can facilitate the flow of air and hinder the flow of liquid to a certain degree.

Referring to FIG. 5, the e-cigarette vaporizing core of the disclosure is mounted within the e-cigarette vaporizer. The e-cigarette vaporizer is provided with a vaporizing base, and the vaporizing base has a cavity allowing for vertical communication. The e-cigarette vaporizing core is entirely mounted in the cavity, with its outer sidewall abutting against the inner sidewall 5 of the cavity. The e-cigarette vaporizing core divides the cavity into an upper cavity 50 and a lower cavity 51. The upper cavity 50 is in communication with the liquid storage chamber of the e-cigarette, and the lower cavity 51 forms the vaporizing chamber. Herein, the outer sidewall of the buffer layer 1 of the e-cigarette vaporizing core abuts against the inner sidewall 5 of the cavity, while the gap 52 is defined between the outer sidewall of the porous ceramic layer 2 and the inner sidewall 5 of the cavity. The width of the gap 52 is namely the aforementioned distance a. During operation of the vaporizing core, the vaporizing liquid in the liquid storage chamber may be adsorbed by the buffer layer 1 from the upper cavity 50, permeate therein, and may be conducted to the porous ceramic layer 2. The vaporizing liquid may further permeate and be conducted to the lower surface of the porous ceramic layer 2. Then, it may be heated to vaporize and atomized into vapor or e-cigarette vapor fog when the heating resistor layer 3 is energized. The vapor may dissipate downwards through the through holes or interstices of the heating resistor layer 3 into the lower cavity 51, namely the vaporizing chamber.

During the operation of the vaporizer, when a user vapes and inhales the e-cigarette vapor fog, a certain negative pressure will be generated in the vaporizing chamber to facilitate the suction of vapor fog or airflow. As the cigarette liquid in the liquid storage chamber is consumed, a certain negative pressure will accumulate in the liquid storage chamber. Such negative pressure is difficult to eliminate due to good seal performance of the liquid storage chamber. According to the vaporizing core of the disclosure, as one side edge of the buffer layer 1 extends beyond the corresponding side edge of the porous ceramic layer 2 by a distance a, the gap 52 can be formed. Thus, when a certain negative pressure is generated in the liquid storage chamber, the gas in the vaporizing chamber 51 can flow upward through the gap 52. As the buffer layer 1 has a great porosity, it allows air to further pass through the interstices or pores inside the buffer layer 1 and holes, flow upward slowly to arrive at the liquid storage chamber. Thus, the negative pressure in the liquid storage chamber can be eliminated. Consequently, during the operation of the vaporizing core, it can avoid the lack of liquid caused by the negative pressure in the liquid storage chamber, the erosion and damage of the porous ceramic layer caused by dry-heating, and the burning taste. The series of arrows on both left and right sides as shown in FIG. 5 indicate the flow direction of the air passing through the gap 52 and internal interstices or pores of the buffer layer 1.

When the e-cigarette vaporizing core is not in operation, the buffer layer 1 which covers the gap 52 adsorbs the vaporizing liquid such that the vaporizing liquid within it has a certain tension at the interstices or pores and holes. In addition, the gap 52, which is namely the distance a, is preferably set to 0.1 mm to 1.2 mm and can facilitate the flow of air and hinder the flow of liquid to a certain degree. Thus, when the pressure difference inside and outside the liquid storage chamber is balanced, the vaporizing liquid will not leak downwards.

The porous ceramic layer of the disclosure is designed to have an integral structure in a cuboid shape without any liquid guiding groove, liquid guiding hole, or airflow through-hole. Thus, the porous ceramic layer is easy to manufacture and produce and has improved yield. It reduces the risk of cracking during high-temperature operation, thereby making the vaporizing core not prone to malfunction. The disclosure is provided with the buffer layer, which tightly abuts on the porous ceramic layer, to prevent the upper surface of the porous ceramic layer from being directly in contact with the vaporizing liquid in the liquid storage chamber, and achieve a certain separation and buffering effects. The vaporizing liquid can first be absorbed by the buffer layer, such that the entire upper surface of the porous ceramic layer can be fully saturated with the vaporizing liquid in the buffer layer. It can ensure sufficient liquid supply, but would not lead to excessive permeation to cause excessive liquid supply and leakage. Furthermore, when the vaporizer is shaken or has low amount of vaporizing liquid, the buffer layer may first adsorb and store sufficient residual vaporizing liquid, thereby maintaining adequate liquid supply to the porous ceramic layer to ensure sufficient and stable vaporization amount.

In other embodiments, in order to enable the buffer layer 1 to have better liquid permeability performance and air permeability performance, the buffer layer 1 may be centrally provided with a through hole 10 extending there-through, as shown in FIG. 6. Furthermore, a plurality of through holes 10 may be provided.

Referring to FIGS. 1-4, the electrode layer 4 in the embodiment may be a conductive metal film, and the heating resistor layer 3 may be a porous metal heating film. The electrode layer 4 and the heating resistor layer 3 may be formed on the surface of the porous ceramic layer 2 by the physical vapor deposition process (also called the magnetron sputtering process) by using different conductive metal materials, respectively. The resistance of the electrode layer 4 may be much smaller than that of the heating resistor layer 3. The electrode layer 4 may be used for conduction without heat generation, while the heating resistor layer 3 may generate heat after being energized. When the metal heating film is formed on the surface of the porous ceramic layer 2 by magnetron sputtering, its thickness is on the micrometer scale, and the holes on the surface of the porous ceramic layer 2 cannot be covered. Thus, the metal heating film naturally will form through-holes, to allow the vaporizing liquid on the surface of the porous ceramic layer 2 to be heated and vaporized to form vapor that escapes and dissipates in the vaporizing chamber.

In the embodiment, in order to enable the buffer layer 1 to have good liquid permeability performance and air permeability performance in addition to the adsorption, isolation, and buffering functions for the vaporizing liquid, the buffer layer 1 may be a soft body made of organic cotton materials. In other embodiments, the buffer layer 1 may also be made of foam metal materials, or polymeric porous materials, organic cotton materials, linen-cotton blend materials, non-woven fabrics, or plant fiber materials.

In other embodiments, the heating resistor layer 3 may also be composed of a metal heating mesh or a porous metal heating sheet.

### Industrial Applicability

All the above are merely preferred embodiments of the disclosure. The present invention is intended to cover all equivalent arrangements and modifications derived from the claims of the present invention.

1. An electrical cigarette vaporizing core, characterized by comprising a buffer layer, a porous ceramic layer, and a heating resistor layer, which are overlapped and tightly connected in sequence, both the buffer layer and the porous ceramic layer are provided all over with numerous non-through tiny interstices or tiny pores for adsorbing, permeating and conducting vaporizing liquid, a porosity of the buffer layer is greater than a porosity of the porous ceramic layer, the heating resistor layer is provided with a plurality of through holes or interstices extending there-through to allow the vaporizing liquid that is vaporized by heating to escape in a vapor form, both ends of one side of the heating resistor layer are connected with electrode terminals for electrically connecting with positive and negative electrodes of a power supply, respectively.

2. The electrical cigarette vaporizing core according to claim 1, wherein the electrode terminals constitute an electrode layer which is arranged between the porous ceramic layer and the heating resistor layer.

3. The electrical cigarette vaporizing core according to claim 1, wherein the buffer layer entirely covers a surface of the porous ceramic layer, with at least an edge of a side of the buffer layer extending beyond an edge of a corresponding side of the porous ceramic layer.

4. The electrical cigarette vaporizing core according to claim 1, wherein a distance that the edge of the side of the buffer layer extending beyond the edge of the corresponding side of the porous ceramic layer is set to 0.1mm to 1.2mm.

5. The electrical cigarette vaporizing core according to claim 1, wherein a thickness of the buffer layer is less than or equal to a thickness of the porous ceramic layer.

6. The electrical cigarette vaporizing core according to claim 1, wherein a thickness of the buffer layer is set to 0.5 mm to 2.0 mm, and a thickness of the porous ceramic layer is set to 1.0 mm to 2.5 mm.

7. The electrical cigarette vaporizing core according to claim 1, wherein the buffer layer is centrally provided with at least one through hole extending there-through.

8. The electrical cigarette vaporizing core according to claim 1, wherein the heating resistor layer is composed of a porous metal heating film, a metal heating mesh, or a porous metal heating sheet.

9. The electrical cigarette vaporizing core according to claim 2, wherein the electrode layer and the heating resistor layer are formed on the surface of the porous ceramic layer by physical vapor deposition process by using different conductive metal materials, respectively, and a resistance of the electrode layer is much smaller than that of the heating resistor layer.

10. The electrical cigarette vaporizing core according to claim 1, wherein the buffer layer is a soft body made of foam metal materials, polymeric porous materials, organic cotton materials, linen-cotton blend materials, non-woven fabrics, or plant fiber materials.
